(19) United States
(12) Patent Application Publication
(10) Pub. No.: US 2018/0097276 A1
(43) Pub. Date: Apr. 5, 2018

(54) ANTENNA APPARATUS

(71) Applicant: FUJITSU LIMITED, Kawasaki-shi (JP)

(72) Inventors: Takashi Yamagajo, Yokosuka (JP); Manabu Kai, Yokohama (JP)

(73) Assignee: FUJITSU LIMITED, Kawasaki-shi (JP)

(21) Appl. No.: 15/706,568

(22) Filed: Sep. 15, 2017

(30) Foreign Application Priority Data
Oct. 4, 2016 (JP) 2016-196592

(51) Int. Cl. H01Q 1/24; G06K 19/077; H01Q 1/48; H01Q 9/42; H01Q 1/38; H01Q 13/08

(52) U.S. Cl. CPC H01Q 1/24; G06K 19/077; H01Q 1/48; H01Q 5/364; H01Q 1/38; H01Q 13/08; H01Q 9/42

(57) ABSTRACT

An antenna apparatus includes a ground plane having an edge; a feed element having a feed point located close to the edge and a first open end, the feed element extending from the feed point to the first open end and serving as an inductor; a parasitic element having a second open end disposed a predetermined distance away from the first open end and a connection end connected to the edge, the parasitic element extending from the connection end to the second open end, a length from the connection end to the second open end being set to be a quarter wavelength of an electrical length of a wavelength in a communication frequency; and a metal member disposed between the first second open ends via a predetermined interval to cover the first and second open ends to constitute a predetermined capacity between the first and second open ends.

### CROSS-REFERENCE TO RELATED APPLICATIONS

This present application is based upon and claims the benefit of priority of the prior Japanese Patent Application No. 2016-196592, filed on Oct. 4, 2016, the entire contents of which are incorporated herein by reference.

### FIELD

The embodiments discussed herein relate to an antenna apparatus.

### BACKGROUND

An antenna apparatus that includes a meandering folded antenna element and a slidable conductive part to be a folded part of the antenna element is known in the related art (for example, see non-patent document 1). The impedance of the antenna apparatus is adjusted by sliding the slidable conductive part to adjust the length from each of the antenna element to the conductive part.

However, in the above antenna apparatus, the slidable conductive part contacts the antenna element. Therefore, electric connection at the contact part is unstabile and it may be difficult to adjust the impedance.

### Related-Art Documents

[Patent Documents]

[Non-Patent Document 1] “Folded Meandered Monopole for Emerging Smart Metering and M2M Applications in the Lower UHF Band” Abraham Loutridis, Matthias John, and Max J. Ammann, IEEE Antennas and Propagation Magazine, vol. 58, no. 2, p. 60-65, 2016.

### SUMMARY

According to an aspect of the embodiments, an antenna apparatus includes a ground plane having an edge; a feed element having a feed point located close to the edge of the ground plane and having a first open end, the feed element extending from the feed point to the first open end and serving as an inductor; a parasitic element having a second open end that is disposed a predetermined distance away from the first open end of the feed element and having a connection end that is connected to the edge of the ground plane, the parasitic element extending from the connection end to the second open end, a length of the parasitic element from the connection end to the second open end being set to be a quarter wavelength of an electrical length of a wavelength in a communication frequency; and a metal member disposed between the first open end and the second open end via a predetermined interval to cover the first open end and the second open end and configured to constitute a predetermined capacity between the first open end and the second open end.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a plan view illustrating an antenna apparatus 100 according to a first embodiment;

FIG. 2 is a perspective view illustrating the antenna apparatus 100 according to the first embodiment;

FIG. 3 is a side view illustrating the antenna apparatus 100 according to the first embodiment

FIG. 4 is a diagram describing fundamentals of an antenna apparatus 100S;

FIG. 5 is a graph illustrating a frequency property of a reflection coefficient (S11-parameter) of the antenna apparatus 100S;

FIG. 6 is a graph illustrating frequency properties of reflection coefficients (S11-parameters) of the antenna apparatus 100S and of a parasitic element 120T;

FIG. 7 is a diagram illustrating a simulation model of the antenna apparatus 100 according to the first embodiment;

FIG. 8 is a graph illustrating frequency properties of reflection coefficients (S11-parameters) obtained by the simulation model illustrated in FIG. 7;

FIGS. 9A and 9B are diagrams illustrating an antenna apparatus 100A;

FIGS. 10A to 10C are diagrams illustrating an antenna apparatus 100B;

FIG. 11 is a diagram illustrating an antenna apparatus 100C;

FIG. 12 is a diagram illustrating an antenna apparatus 100D;

FIGS. 13A and 13B are diagrams illustrating variation examples of the embodiment;

FIGS. 14A and 14B are diagrams illustrating variation examples of the embodiment;

FIG. 15 is a diagram illustrating a variation example of the embodiment;

FIG. 16 is a graph illustrating a frequency property of reflection coefficients (S11-parameters) of an antenna apparatus 100V5; and

FIG. 17 is a diagram illustrating an antenna apparatus 100V6.

### DESCRIPTION OF EMBODIMENT

Hereinafter, embodiments will be described to which an antenna apparatus of the present invention is applied. One aspect of the embodiments is to provide an antenna apparatus for which impedance can be easily adjusted.

### First Embodiment

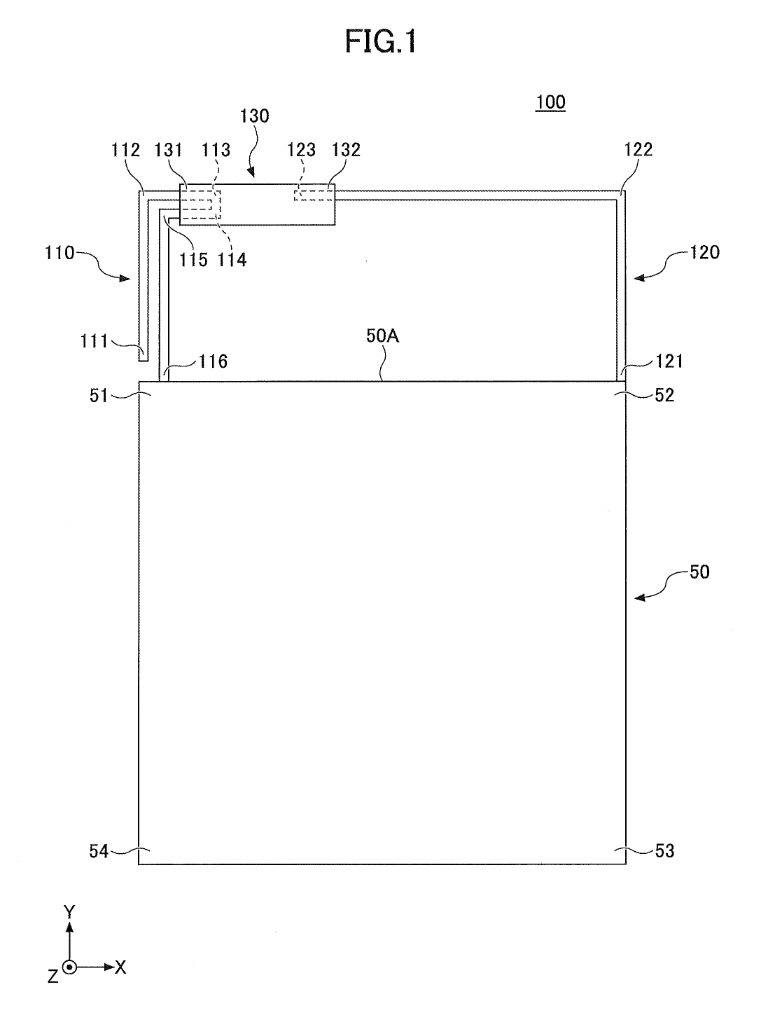

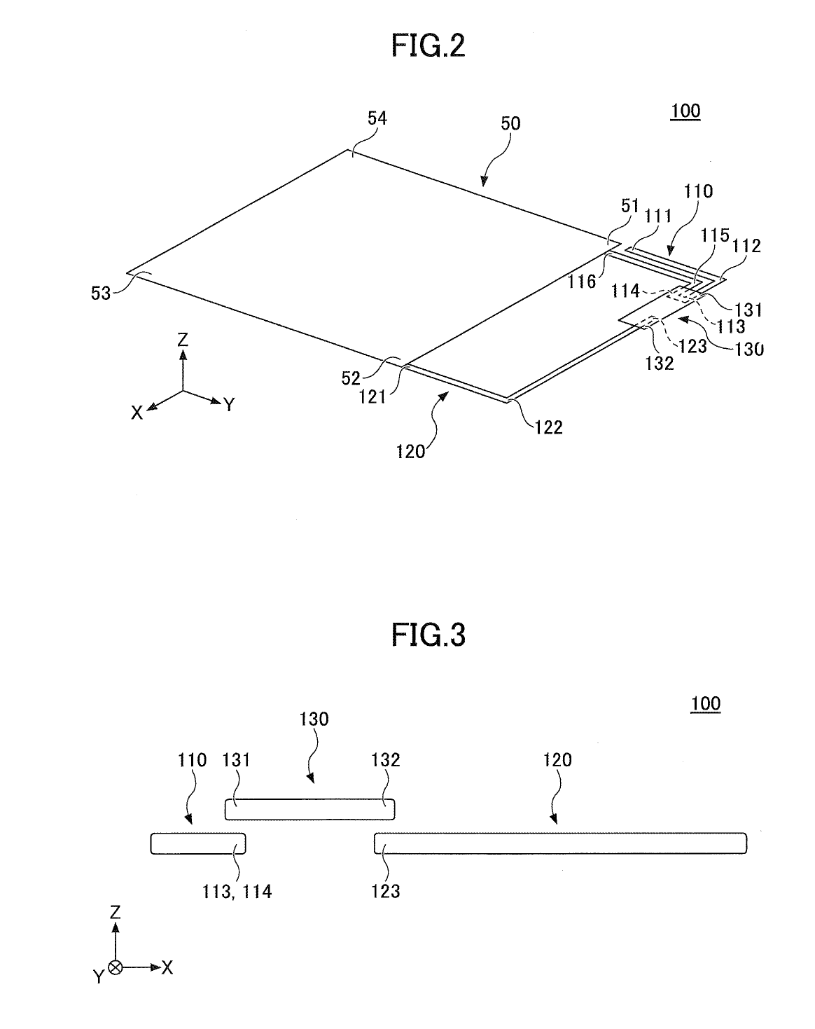

FIG. 1 is a plan view illustrating an antenna apparatus 100 according to a first embodiment. FIG. 2 is a perspective view illustrating the antenna apparatus 100 according to the first embodiment. FIG. 3 is a side view illustrating the antenna apparatus 100 according to the first embodiment. In the following description, an XYZ coordinate system is used as illustrated in FIG. 1 to FIG. 3.

The antenna apparatus 100 includes a ground plane 50, a feed element 110, a parasitic element 120, and a metal sheet 130. Note that the ground plane 50 is omitted in FIG. 3.

The ground plane 50 is used as a ground potential layer of the antenna apparatus 100. The ground plane 50 may be treated as a grounding plate or an earth plate. The ground plane 50 has a corner part 51 that is located at a negative side in the X axis direction and at a positive side in the Y axis direction, a corner part 52 that is located at a positive side in the X axis direction and at a positive side in the Y axis direction, a corner part 53 that is located at a positive side in the X axis direction and at a negative side in the Y axis direction, and a corner part 54 that is located at a negative side in the X axis direction and at a negative side in the Y axis direction. In the following, a line that connects the corner part 51 and the corner part 52 is referred to as an edge 50A. The edge 50A extends along the X axis.

The feed element 110 has a feed point 111, folded parts 112, 113, 114, and 115, and a grounded end 116. The feed point 111 is located close to the positive side of the corner part 51 in the Y axis direction. For example, the feed point 111 is connected to a wireless module via a microstripline or a core wire of a coaxial cable, and electric power is fed to the feed point 111. Further, the corner part 51 is connected to a ground potential wire included in the microstripline or to a shielded wire of the coaxial cable. A point of the corner part 51 to which the shielded wire of the coaxial cable or the like is connected may be treated as a ground potential point. The ground potential point is a point of the ground plane 50 side corresponding to the feed point.

The feed element 110 extends from the feed point 111 to the positive side in the Y axis direction, is folded at the folded part 112 to extend to the positive side in the X axis direction, is folded at the folded part 113 to extend in the negative side in the Y axis direction, is folded at the folded part 114 to the negative side in the X axis direction, is folded at the folded part 115 to extend to the negative side in the Y axis direction, and is connected, at the grounded end 116, to a point close to the positive side of the corner part 51 in the X axis direction.

The feed element 110 is a loop-shaped feed element that extends from the feed point 111 to the folded parts 113 and 114 and further extends from the folded parts 113 and 114 to return to the grounded end 116. Hence, the folded parts 113 and 114 may be treated as an open end. The folded parts 113 and 114 are an example of a first open end.

The feed element 110 is set such that the length from the feed point 111 to the grounded end 116 is less than a quarter length of an electrical length of one wavelength (λ) in a communication frequency (resonant frequency) of the antenna apparatus 100. That is, the length from the feed point 111 to the grounded end 116 is less than λ/4. The feed element 110 serves as an inductor in which a loop electric current flows in a loop with a mirror image generated at the ground plane 50 (loop whose length is twice the length from the feed point 111 to the grounded end 116). The feed element 110 is provided to feed electric power to the parasitic element 120 and to match the impedance of the antenna apparatus 100.

The parasitic element 120 has a grounded end 121, a folded part 122, and a leading end part 123. Here, the parasitic element is a radiating element, which does not have a feed point, to be supplied via another element. The parasitic element 120 extends from the grounded end 121, connected to the corner part 52 of the ground plane 50, to the positive side in the Y axis direction, and is folded at the folded part 122 to extend toward the negative in the X axis direction to the leading end part 123. A position of the leading end part 123 is a position of the folded part 113 in the Y axis direction. The leading end part 123 is disposed a predetermined distance away from the folded part 113. The leading end part 123 is an example of a second open end. Note that a position of the folded part 122 is equal to a position of the folded part 112 in the Y axis direction.

The parasitic element 120 is fed with electric power from the feed element 110 via the metal sheet 130. A length of the parasitic element 120 from the grounded end 121 to the leading end part 123 via the folded part 122 is set to be a quarter length of an electrical length of one wavelength λ in a communication frequency (resonant frequency) of the antenna apparatus 100. That is, the length from the grounded end 121 to the leading end part 123 via the folded part 122 is set to be λ/4.

Because the parasitic element 120 has the quarter length of the electrical length of the wavelength λ in the communication frequency, the parasitic element 120 acts as a monopole antenna. Hence, the parasitic element 120 serves as a dipole antenna in coordination with a mirror image generated at the ground plane 50. Because the parasitic element 120 is fed with electric power at the leading end part 123, an electric field at the leading end part 123 is the strongest.

The metal sheet 130 is a rectangular metal sheet having end parts 131 and 132. The metal sheet 130 is disposed to overlap with the folded parts 113 and 114 and the leading end part 123 via a sheet-shaped insulator (insulation sheet) extending in an XY plane (not illustrated).

The end part 131 of the metal sheet 130 is capacitively connected to the folded parts 113 and 114 in the Z axis direction, and the end part 132 of the metal sheet 130 is capacitively connected to the leading end part 123 in the Z axis direction. An interval between the end part 131 and the folded parts 113 and 114 in the Z axis direction and an interval between the end part 132 and the leading end part 123 in the Z axis direction are determined depending on a thickness of the insulation sheet provided between the metal sheet 130 and the elements 110 and 120.

An electrostatic capacity between the end part 131 and the folded parts 113 and 114 is determined depending on the interval between the end part 131 and the folded parts 113 and 114 in the Z axis direction and on an area in which the end part 131 and the folded parts 113 and 114 overlap.

Further, an electrostatic capacity between the end part 132 and the leading end part 123 is determined depending on the interval between the end part 132 and the leading end part 123 in the Z axis direction and on an area in which the end part 132 and the leading end part 123 overlap. In other words, the metal sheet 130, which is an example of a metal member, may be disposed via a predetermined interval with respect to the folded parts 113 and 114 and the leading end part 123 to cover the folded parts 113 and 114 and the leading end part 123 and to constitute a predetermined capacity (capacitance) between the folded parts 113 and 114 and the leading end part 123. As illustrated in FIGS. 1 to 2, the width of the metal sheet 130 may be wider than the line widths of the feed element 110 and the parasitic element 120.

For example, a communication frequency of the antenna apparatus 100 is in a high frequency band of from several hundreds of MHz to several GHz. Therefore, the feed element 110 and the parasitic element 120 are connected through the metal sheet 130 in a high frequency manner.

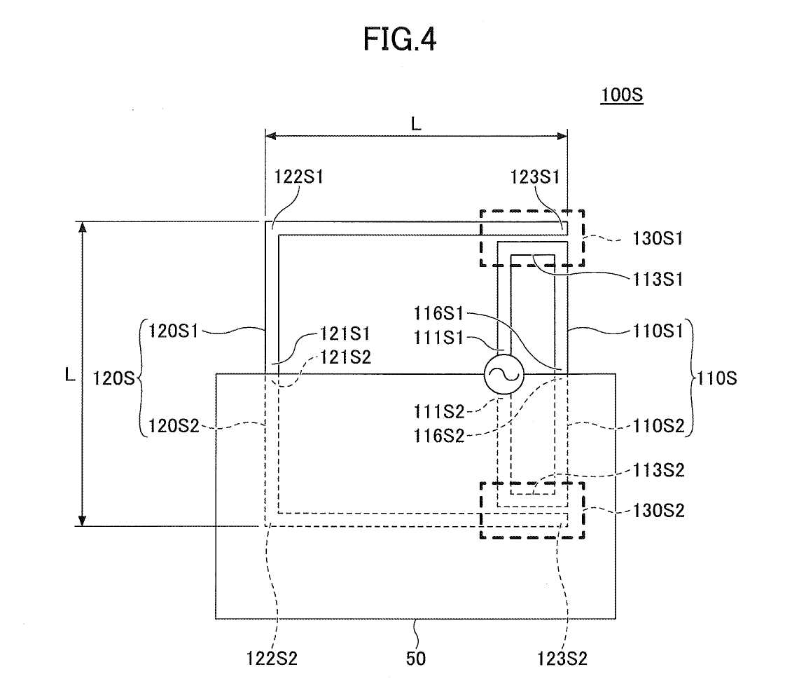

FIG. 4 is a diagram describing fundamentals of an antenna apparatus 100S.

The antenna apparatus 100S includes a ground plane 50, a feed element 110S, a parasitic element 120S, and metal sheets 130S1 and 130S2. The feed element 110S is constituted by a feed element 110S1 and a feed element 110S2. The parasitic element 120S is constituted by a parasitic element 120S1 and a parasitic element 120S2.

The feed element 110S1 has a U-shaped structure obtained by simplifying the structure of the feed element 110 illustrated in FIG. 1 and FIG. 2. The feed element 110S1 has a feed point 111S1, a folded part 113S1, and a grounded end 116S1. The feed element 110S2 represents a mirror image of the feed element 110S1 generated at the ground plane 50. Because the feed element 110S2 is the mirror image, the feed element 110S2 is represented by dotted lines. The feed element 110S2 has a feed point 111S2, a folded part 113S2, and an end part 116S2. Note that FIG. 4 illustrates a symbol for alternating current between the feed points 111S1 and 111S2.

The feed element 110S1 and the feed element 110S2 of the feed element 110S form a loop-shaped radiating element, and the loop length is less than half of an electrical length of one wavelength in a communication frequency (the loop length is less than λ/2). Therefore, the feed element 110S serves as an inductor.

The parasitic element 120S1 has a grounded end 121S1, a folded part 122S1, and a leading end part 123S1. The leading end part 123S1 is located close to the folded part 113S1. The leading end part 123S1 and the folded part 113S1 are covered by the metal sheet 130S1.

The parasitic element 120S2 has an end part, a folded part 122S2, and a leading end part 123S2. The leading end part 123S2 is located close to the folded part 113S2. The leading end part 123S2 and the folded part 113S2 are covered by the metal sheet 130S2.

According to such an antenna apparatus 100S, the feed element 110S serves as a matching circuit, electric power is fed from the feed element 110S to the leading end parts 123S1 and 123S2 located close to the folded parts 113S1 and 113S2 of the feed element 110S, and the parasitic element 120S serves as a dipole antenna. In this way, the antenna apparatus 100S becomes able to communicate.

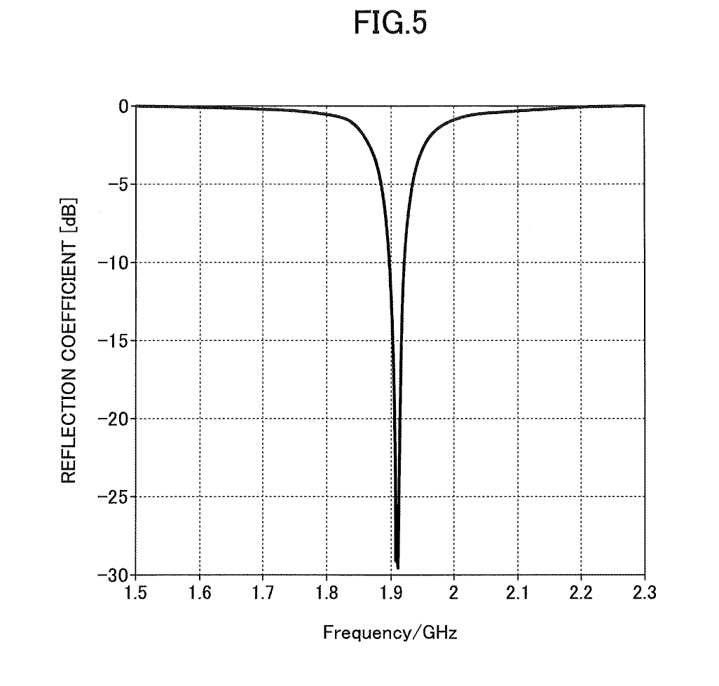

FIG. 5 is a graph illustrating a frequency property of a reflection coefficient (S11-parameter) of the antenna apparatus 100S. The frequency property of the reflection coefficient illustrated in FIG. 5 is obtained when a dimension L of the parasitic element 120S in FIG. 4 (the length between the grounded end 121S1 and the folded part 122S1, the length between the folded part 122S1 and the folded part 122S2, and the length between the folded part 122S and the leading end part 123S2) is set to be 1/7.2 of the electrical length (λ) of one wavelength in 1.9 GHz (L is set to be λ/7.2).

As illustrated in FIG. 5, at approximately 1.9 GHz, a preferable value at which the value of the S11-parameter is equal or less than −5 dB to −10 dB is obtained. Hence, it is found that the antenna apparatus 100S illustrated in FIG. 4 can have a favorable communication property in a band of approximately 1.9 GHz.

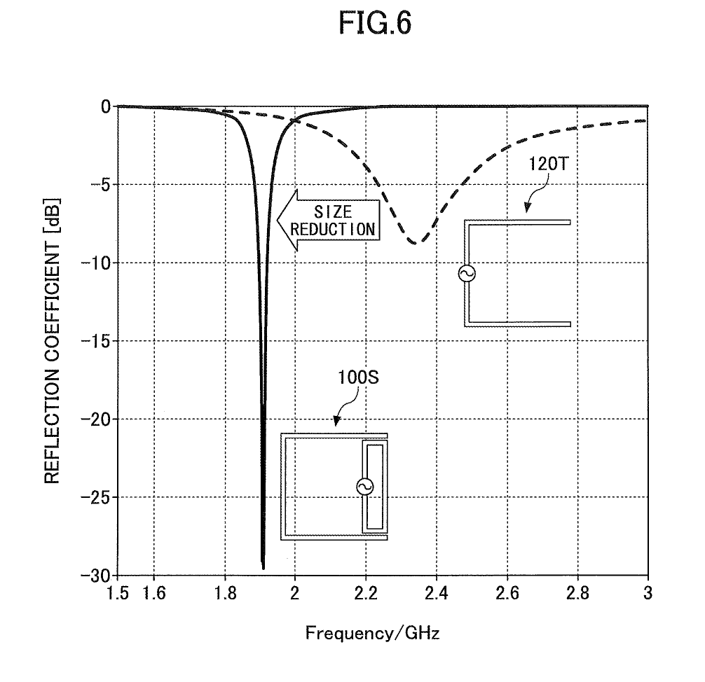

FIG. 6 is a graph illustrating frequency properties of reflection coefficients (S11-parameters) of the antenna apparatus 100S and of a parasitic element 120T. Here, the S11-parameter of the antenna apparatus 100S is represented by the solid line, and the S11-parameter obtained by the parasitic element 120T alone for comparison is represented by a broken line. The parasitic element 120T is a radiating element obtained by replacing a mirror image part of the parasitic element 120S (the parasitic element 120S2) with an element. The radiating element is fed with electric power between the grounded end 121S1 and the end part 121S2. Note that the frequency property of the S11-parameter illustrated by the solid line in FIG. 6 is the same as that illustrated in FIG. 5.

As illustrated in FIG. 6, in the frequency property of the S11-parameter obtained by the parasitic element 120T alone, a resonant frequency is approximately 2.35 GHz. Thus, it is found that the resonant frequency of the antenna apparatus 100S is lower than the resonant frequency of the parasitic element 120T. This effect is obtained by the feed element 1105, which serves as an inductor, adjusting the impedance of the parasitic element 1205.

That is, it is found that it is possible to reduce the resonant frequency of the antenna apparatus 100S to be lower than the resonant frequency of the parasitic element 120T, and to relatively reduce the size of the antenna apparatus 1005.

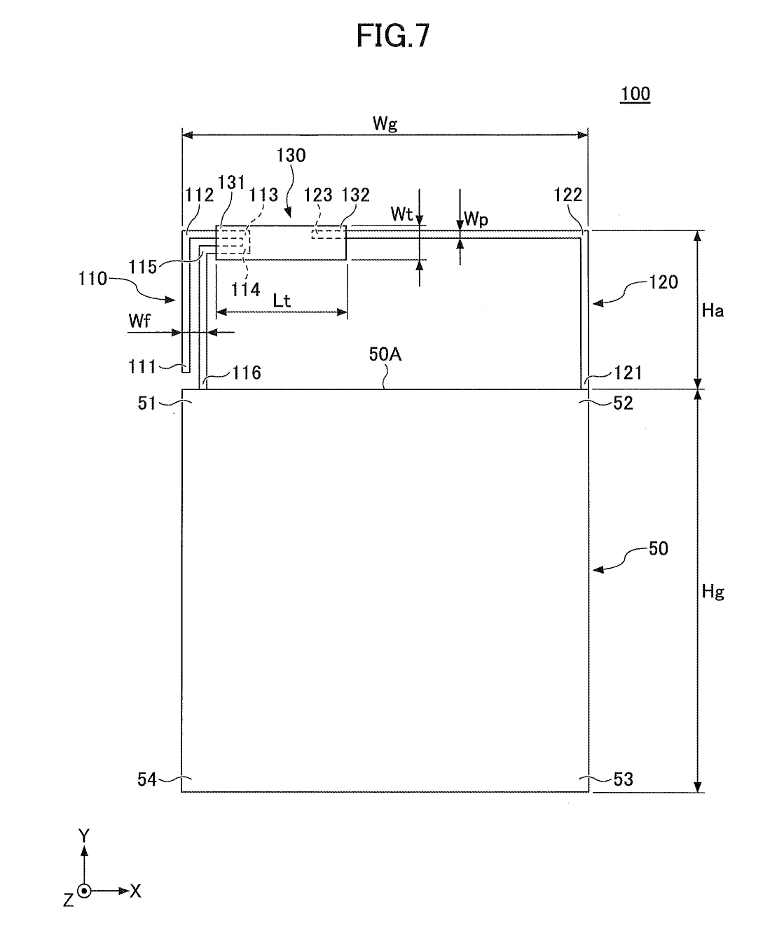

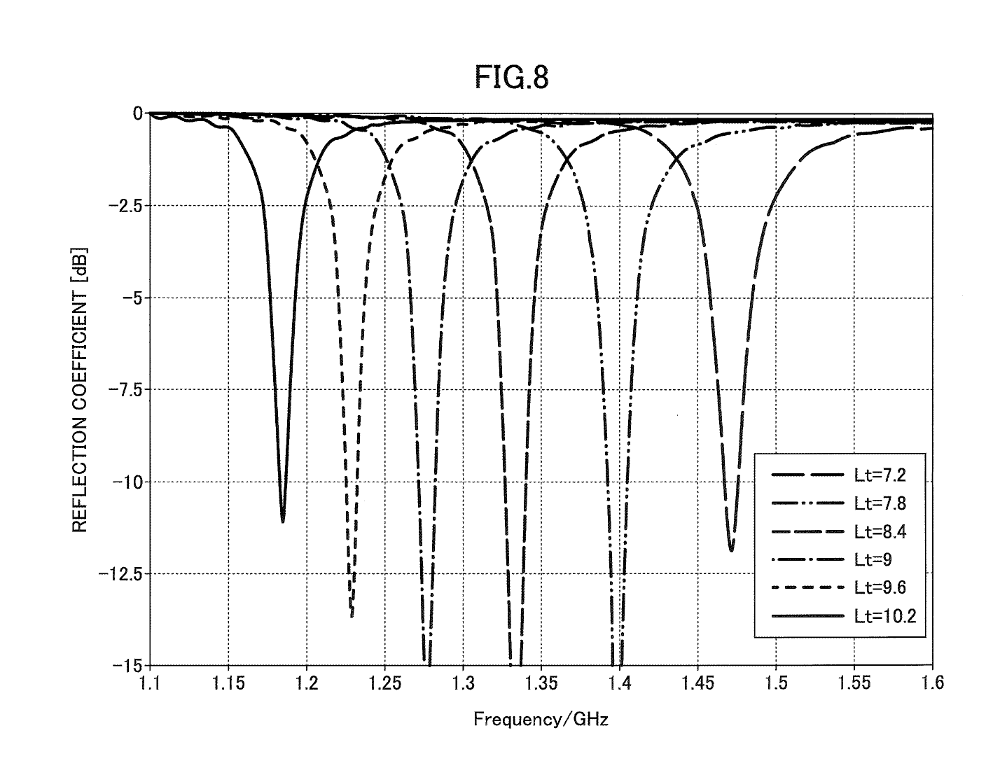

FIG. 7 is a diagram illustrating a simulation model of the antenna apparatus 100 according to the first embodiment. FIG. 8 is a graph illustrating frequency properties of reflection coefficients (S11-parameters) obtained by the simulation model illustrated in FIG. 7.

As illustrated in FIG. 7, a length Ha of the feed element 110 from the feed point 111 to the folded part 112 (a length of the parasitic element 120 from the grounded end 121 to the folded part 122) is set to be 12 mm (λ/19), and a length Wg from the folded part 112 of the feed element 110 to the folded part 122 of the parasitic element 120 is set to be 30.6 mm (λ/7). Note that λ illustrated here is the electrical length of one wavelength in 1.35 GHz.

Further, an outer lengh Wf in the X axis direction between the line of the feed element 110 from the feed point 111 to the folded part 112 and the line from the folded part 115 to the grounded end 116 is set to be 3.5 mm, and a line width Wp of each of the feed element 110 and the parasitic element 120 is set to be 0.6 mm. A length Hg of the ground plane 50 in the Y axis direction is set to be 30.6 mm (λ/7).

Under such conditions, the S11-parameters (dB) of the simulation model are obtained while changing a length Lt of the metal sheet 130 in the X axis direction. Note that a length by which the metal sheet 130 overlaps with the folded parts 113 and 114 of the feed element 110 in the X axis direction is set to be equal to a length by which the metal sheet 130 overlaps the leading end part 123 of the parasitic element 120 in the X axis direction. Further, in the Y axis direction, the metal sheet 130 completely covers the folded parts 113 and 114 of the feed element 110 and the leading end part 123 of the parasitic element 120.

When the length Lt is changed from 7.2 mm to 10.2 mm, the reflection coefficient changes as illustrated in FIG. 8. As the length Lt increases, the frequency at which the local minimum value of the reflection coefficient (resonant frequency) is obtained decreases. Specifically, when the length Lt is 7.2 mm, the resonant frequency is approximately 1.5 GHz. When the length Lt becomes 10.2 mm, the resonant frequency decreases to approximately 1.2 GHz.

From such a result, it can be confirmed that by changing the length Lt of the metal sheet 130 to change the electrostatic capacity between the metal sheet 130, the feed element 110, and the parasitic element 120, the impedance of the antenna apparatus 100 can be adjusted and the communication frequency (resonant frequency) of the antenna apparatus 100 can be adjusted.

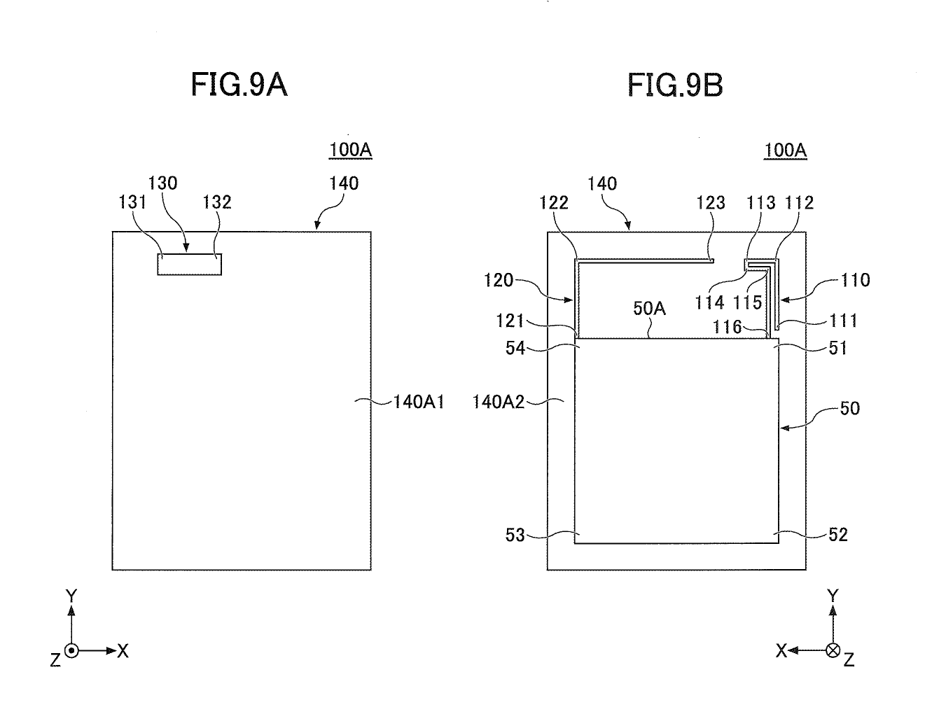

FIGS. 9A and 9B are diagrams illustrating an antenna apparatus 100A. The antenna apparatus 100A illustrated in FIGS. 9A and 9B includes the ground plane 50, the feed element 110, the parasitic element 120, the metal sheet 130, and a polyethylene terephthalate (PET) film 140.

As illustrated in FIG. 9A, the metal sheet 130 is provided on a front surface 140A1 of the PET film 140. As illustrated in FIG. 9B, the ground plane 50, the feed element 110, and the parasitic element 120 are provided on a back surface 140A2 of the PET film 140.

The ground plane 50, the feed element 110, and the parasitic element 120 are formed on the back surface 140A2 of the PET film 140. For example, the ground plane 50, the feed element 110, and the parasitic element 120 may be provided on the back surface 140A2 by screen-printing a silver paste or the like on the back surface 140A2, or by etching foil such as aluminum foil or copper foil on the back surface 140A2.

For example, the metal sheet 130 may be a sheet obtained by applying or printing an adhesive agent to a tape made of aluminum. By attaching such a metal sheet 130 to the surface 140A1 of the PET film 140, the impedance of the antenna apparatus 100A can be adjusted in accordance with the attached position. This is because an area (ie. cm², etc.), in which the feed element 110, the parasitic element 120, and the metal sheet 130 overlap, is changed in accordance with a position at which the metal sheet 130 is attached.

In this case, by having a configuration such that the metal sheet 130 can be repeatedly attached to the surface 140A1 of the PET film 140, the impedance of the antenna apparatus 100A can be adjusted while adjusting the position of the metal sheet 130 with respect to the feed element 110 and the parasitic element 120. Here, a configuration in which the metal sheet 130 is repeatedly attachable is a configuration in which after the metal sheet 130 is attached to the surface 140A1, an operation can be repeatedly performed to remove (peel off) the metal sheet 130 from the surface 140A1 and to attach again the metal sheet 130 to the surface 140A1. For example, an adhesive agent or the like may be applied to the surface 140A1, to which the metal sheet 130 is attached, such that the applied adhesive agent enables to attach and peel off the metal sheet 130 repeatedly. The metal sheet 130 may be attached to the surface 140A1 at least twice.

The feed element 110 and the parasitic element 120 are not electrically connected to the metal sheet 130 and are separated from the metal sheet 130 by the thickness of the PET film 140. Therefore, electric contact between the feed element 110 and the parasitic element 120 and the metal sheet 130 does not cause a problem, and the impedance of the antenna apparatus 100A can be easily adjusted by adjusting an area in which the feed element 110 and the parasitic element 120 overlap with the metal sheet 130.

Note that if a use (application) of the antenna apparatus 100A is fixed, it is not necessary to have a configuration in which the metal sheet 130 can be repeatedly attached to the surface 140A1. In this case, the metal sheet 130A may be formed by printing or etching it on the surface 140A1. If a use (application) of the antenna apparatus 100A is fixed, a device or the like to which the antenna apparatus 100A is to be attached is fixed, and a position and a size of the metal sheet 130 are fixed with respect to the feed element 110 and the parasitic element 120.

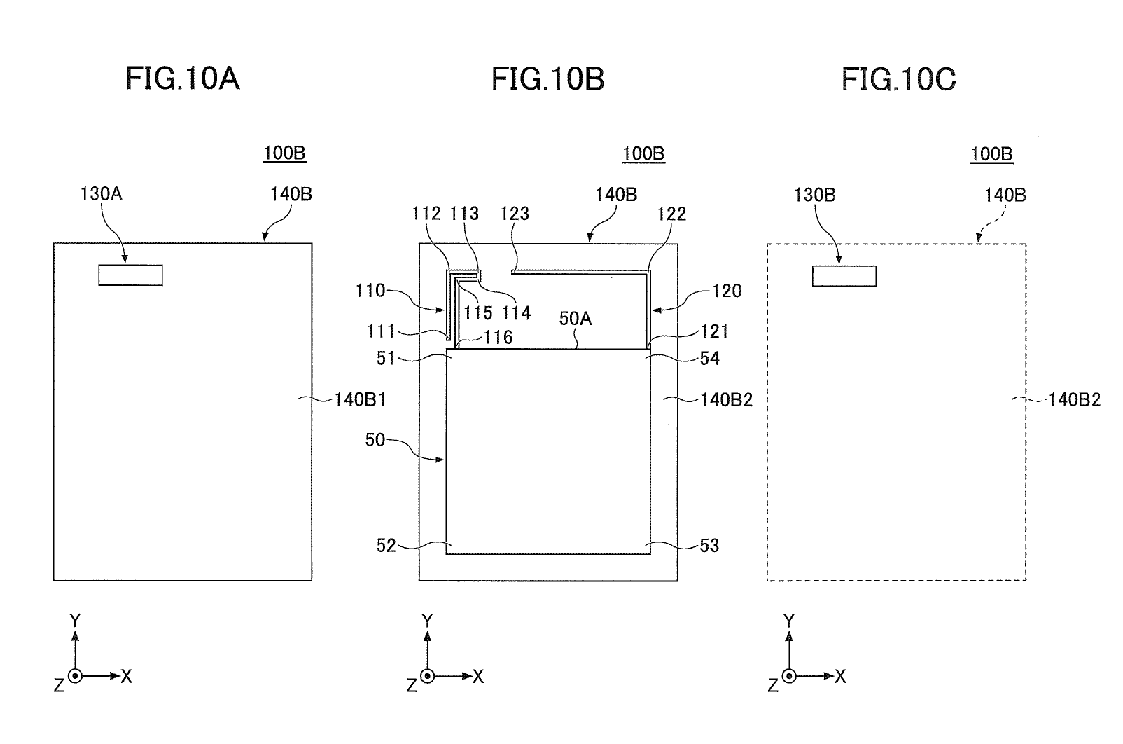

FIGS. 10A to 10C are diagrams illustrating an antenna apparatus 100B. The antenna apparatus 100B illustrated in FIGS. 10A to 10C includes the ground plane 50, the feed element 110, the parasitic element 120, metal sheets 130A and 130B, and a wiring substrate 140B. The wiring substrate 140B is a printed substrate and includes insulating layers 140B1 and 140B2.

FIG. 10A illustrates the L1 layer of the wiring substrate 140B, FIG. 10B illustrates the L2 layer of the wiring substrate 140B, and FIG. 10C illustrates the L3 layer of the wiring substrate 140B. The L1 layer is a wiring layer located at a front surface (a positive side surface in the Z axis direction) of the insulating layer 140B1. The L2 layer is a wiring layer located between the insulating layer 140B1 and the insulating layer 140B2. The L3 layer is a wiring layer located at a back surface (a negative side surface in the Z axis direction) of the insulating layer 140B2.

As illustrated in FIG. 10A, the metal sheet 130A is provided on the front surface (the positive side surface in the Z axis direction) of the insulating layer 140B1. Similar to the metal sheet 130 illustrated in FIG. 9A, the metal sheet 130A has a configuration in which the metal sheet 130A can be repeatedly attached to the surface of the insulating layer 140B1.

Further, as illustrated in FIG. 10B, the ground plane 50, the feed element 110, and the parasitic element 120 are provided on the front surface (the positive side surface in the Z axis direction) of the insulating layer 140B2 The ground plane 50, the feed element 110, and the parasitic element 120 may be provided on the surface of the insulating layer 140B2 by screen-printing a silver paste or the like on the surface of the insulating layer 140B2, or by etching foil such as aluminum foil or copper foil on the surface of the insulating layer 140B2.

The insulating layer 140B2 is bonded with the insulating layer 140B1 in a state in which the ground plane 50, the feed element 110, and the parasitic element 120 are formed on the surface of the insulating layer 140B2. Note that the insulating layer 140B1 may be bonded with the insulating layer 140B2 in a state in which the ground plane 50, the feed element 110, and the parasitic element 120 are formed on the back surface (the negative side surface in the Z axis direction) of the insulating layer 140B1.

In FIG. 10C, a position of the insulating layer 140B2 is illustrated by a broken line. The metal sheet 130B is provided on the back surface (the negative side surface in the Z axis direction) of the insulating layer 140B2. Similar to the metal sheet 130A, the metal sheet 130B has a configuration in which the metal sheet 130B can be repeatedly attached to the back surface of the insulating layer 140B2.

According to such an antenna apparatus 100B, by adjusting positions where the metal sheet 130A and the metal sheet 130B are respectively attached to the front surface of the insulating layer 140B1 and the back surface of the insulating layer 140B2, the impedance of the antenna apparatus 100B can be easily adjusted.

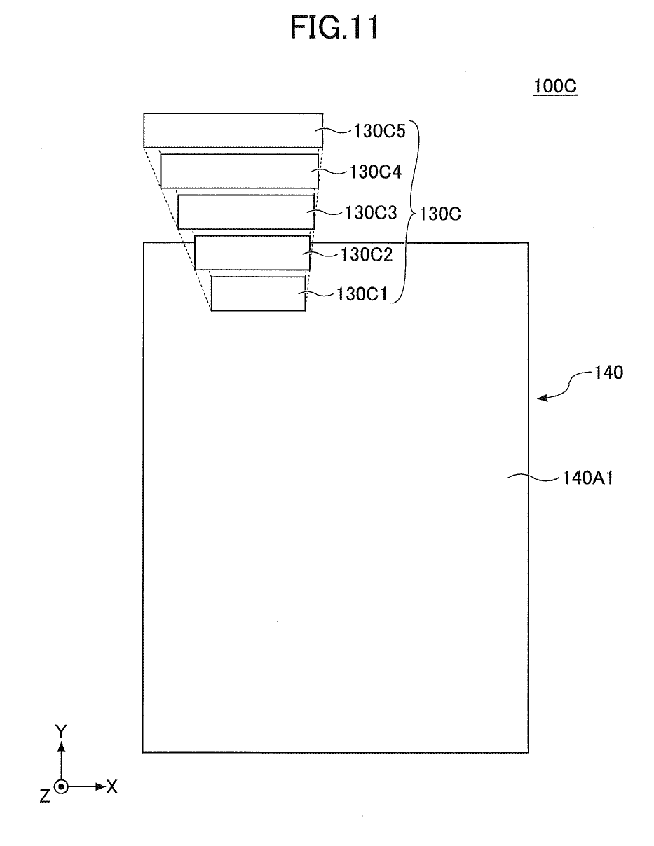

FIG. 11 is a diagram illustrating an antenna apparatus 100C. The antenna apparatus 100C includes a metal sheet 130C instead of the metal sheet 130 of the antenna apparatus 100A illustrated in FIGS. 9A and 9B. FIG. 11 illustrates only a configuration corresponding to FIG. 9A.

The metal sheet 130C has a configuration where five metal sheets 130C1 to 130C5 are stacked to be bonded. The length of the metal sheets 130C1 to 130C5 increases in the X axis direction in order from the metal sheet 130C1 to the metal sheet 130C5. The metal sheet 130C1 is attached to the surface 140A1 of the PET film 140, and on the metal sheet 130C1, the metal sheets 130C2, 130C3, 130C4, and 130C5 are attached in this order. In other words, the lengths of the metal sheets 130C1 to 130C5 may differ from each other in the X axis direction, which is a direction connecting the folded parts 113 and 114 of the feed element 110 and the folded part 123 of the parasitic element 120 (see FIGS. 9A and 9B). Further, the lengths in the X axis direction of the metal sheets 130C1 to 130C5 may shorten (decrease) with decreasing distance to the folded parts 113 and 114 and the folded part 123 in the Z axis direction, which is a direction of stacking the metal sheets 130C1 to 130C5 with respect to the folded parts 113 and 114 and the folded part 123. The lengths in the X axis direction of the metal sheets 130C1 to 130C5 may lengthen (increase) with increasing distance from the folded parts 113 and 114 and the folded part 123 in the Z axis direction.

Because the metal sheets 130C1 to 130C5 can be peeled off individually (one by one) from the metal sheet 130C5, the length of the metal sheet 130C can be adjusted in the X axis direction. For example, by peeling off the metal sheets 130C5 and 130C4, a metal sheet 130C in which the metal sheets 130C1 to 130C3 are superimposed can be used.

All the metal sheets 130C1 to 130C5 are attached to the surface 140A1 of the PET film 140 so as to overlap with the folded parts 113 and 114 of the feed element 110 and the leading end part 123 of the parasitic element 120.

Therefore, by adjusting a position where the metal sheets 130C1 to 130C5 are attached to the surface 140A1 of the PET film 140 while repeatedly attaching them, a planar position of the metal sheets 130C1 to 130C5 can be adjusted with respect to the folded parts 113 and 114 and the leading end part 123.

Further, the length in the X axis direction by which the metal sheet 130C overlaps with the folded parts 113 and 114 and the leading end part 123 can be adjusted by peeling off one by one from the metal sheet 130C5.

In this way, according to the antenna apparatus 100C, by adjusting the position, at which the metal sheet 130C is attached to the surface 140A1 of the PET film 140, and adjusting the length in the X axis direction of the metal sheet 130C, the impedance of the antenna apparatus 100C can be easily adjusted.

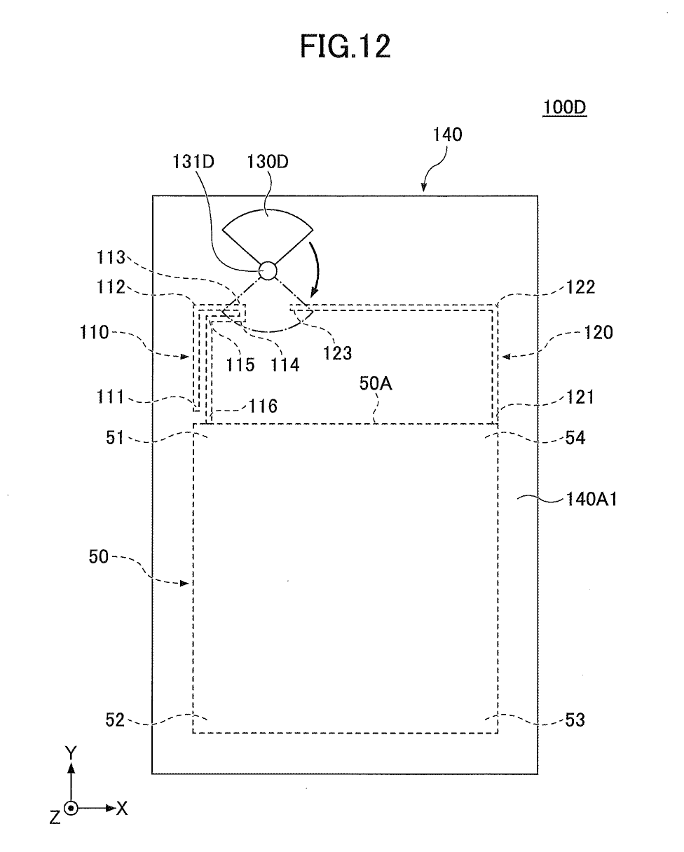

FIG. 12 is a diagram illustrating an antenna apparatus 100D. The antenna apparatus 100D includes a fan-shaped metal sheet 130D instead of the metal sheet 130C illustrated in FIG. 11.

The metal sheet 130D is rotatably supported by a rotation shaft 130D with respect to the PET film 140. By adjusting a rotation angle of such a metal sheet 130D, the area, in which the metal sheet 130D overlaps with the folded parts 113 and 114 of the feed element 110 and the leading end part 123 of the parasitic element 120, can be adjusted and the impedance of the antenna apparatus 100D can be adjusted.

As described above, according to the embodiment, it is possible to provide the antenna apparatuses 100, 100S, 100A, 100B, 100C, and 100D with which the impedance can be easily adjusted (hereinafter, referred to as the antenna apparatus 100).

For example, in Internet of Things (IOT) or Machine to Machine (M2M), the antenna apparatus 100 may be attached to any objects such as personal belongings to perform communications. A radiation property of the antenna apparatus 100 largely varies depending on an electric permittivity, an electric conductivity, or the like of an object to which the antenna apparatus 100 is attached. Therefore, by realizing a configuration for which impedance can be easily adjusted, the radiation property can be optimized when the antenna apparatus 100 is attached to an object.

Further, because a frequency band to be allocated to IOT or M2M is not determined, an antenna apparatus 100 having a configuration for which the impedance can be easily adjusted is very promising for IOT or M2M to be used in future.

Note that although the fan-shaped metal sheet 130D is used in the embodiment described here, the metal sheet 130D may have any suitable shape or configuration if the metal sheet 130D can be rotatably supported by the rotation shaft 131D with respect to the PET film 140 and the area, in which the metal sheet 130D overlaps with the folded parts 113 and 114 of the feed element 110 and the leading end part 123 of the parasitic element 120, can be adjusted

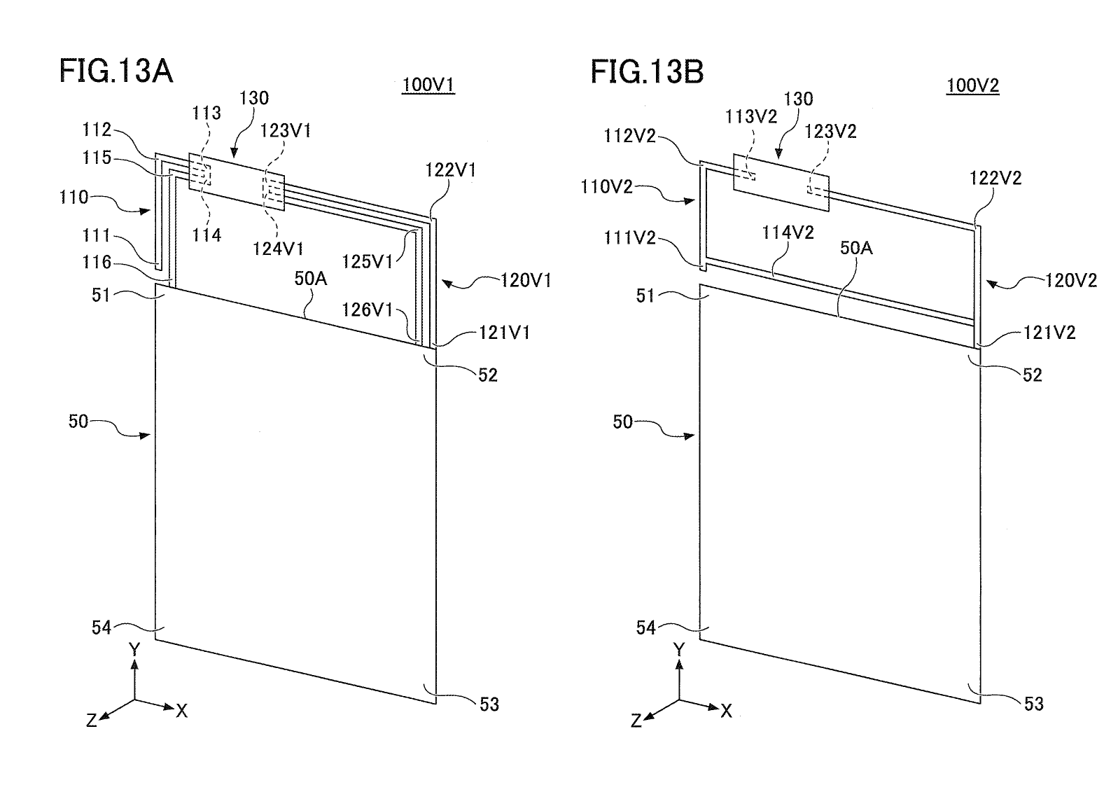

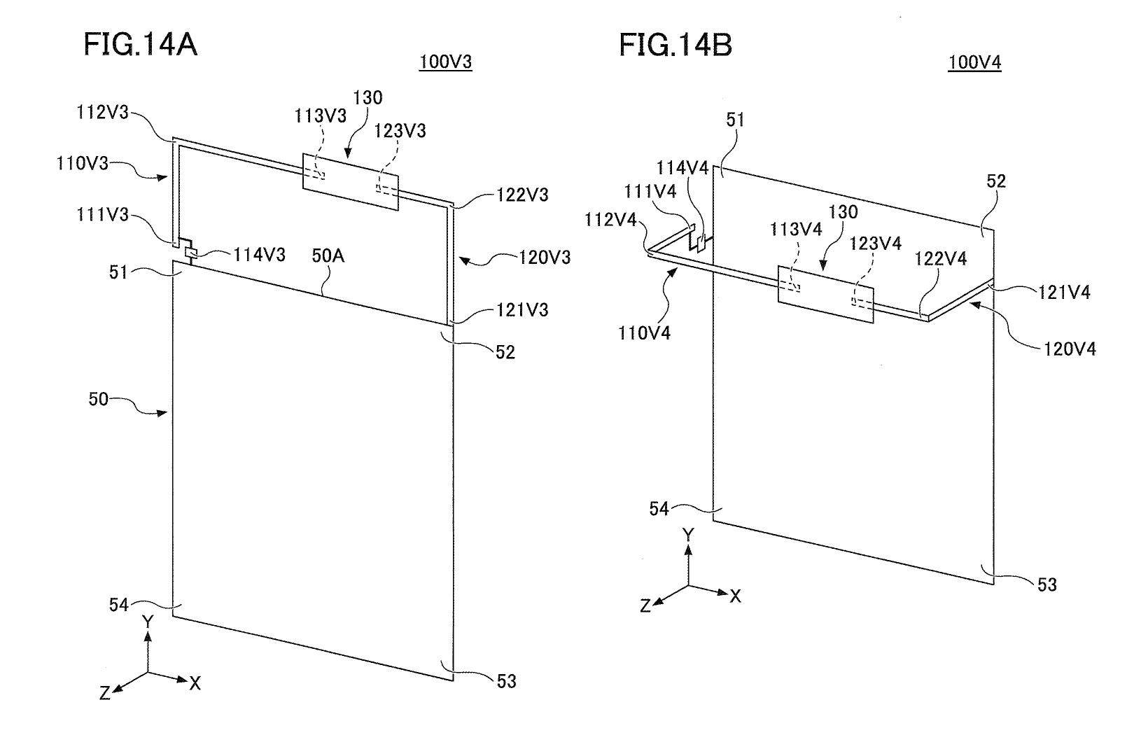

FIG. 13 and FIG. 14 are diagrams illustrating variation examples of the embodiment.

An antenna apparatus 100V1 illustrated in FIG. 13A includes the ground plane 50, the feed element 110, a parasitic element 120V1, and the metal sheet 130. The antenna apparatus 100V1 includes the parasitic element 120V1 instead of the parasitic element 120 illustrated in FIG. 1.

The parasitic element 120V1 has a monopole type configuration, and has a grounded end 121V1, folded parts 122V1, 123V1, 124V1, and 125V1, and a grounded end 126V1. The grounded end 121V1 is an example of a first connection end, and the grounded end 126V1 is an example of a second connection end.

The parasitic element 120V1 has a configuration where the grounded ends 121V1 and 126V1, which are both ends, are connected to the ground plane 50, and the parasitic element 120V1 extends from the grounded end 121V1 to the folded parts 123V1 and 124V1 to return to the grounded end 126V1. A length from the grounded end 121V1 to the grounded end 126V1 is set to be a half length of an electrical length of one wavelength λ in a communication frequency (resonant frequency) of the antenna apparatus 100V1. That is, the length from the grounded end 121V1 to the grounded end 126V1 is set to be λ/2.

Even under such an antenna apparatus 100V1, by adjusting the position of the metal sheet 130, the impedance can be easily adjusted.

An antenna apparatus 100V2 illustrated in FIG. 13B includes the ground plane 50, a feed element 110V2, a parasitic element 120V2, and the metal sheet 130.

The feed element 110V2 has a feed point 111V2, a folded part 112V2, an open end 113V2, and a loop part 114V2. A part from the feed point 111V2 to the open end 113V2 via the folded part 112V2 is set to have a quarter length (λ/4) of an electrical length of one wavelength λ in a communication frequency (resonant frequency) to serve as a monopole antenna.

Further, the loop part 114V2 extends, along the edge 50A, from a position between the feed point 111V2 and the folded part 112V2 to be connected to the parasitic element 120V2. The point from which the loop part 114V2 branches off between the feed point 111V2 and the folded part 112V2 is closer to the feed point 111V2 than the folded part 112V2. That is, the loop part 114V2 branches off the position in the vicinity of the feed point 111V1.

The loop part 114V2 is an example of a connection element. The point at which the loop part 114V2 is connected to the line between the feed point 111V2 and the folded part 112V2 is an example of a first point.

The parasitic element 120V2 has a grounded end 121V2, a folded part 122V2, and an open end 123V2. A part from the grounded end 121V2 to the open end 123V2 via the folded part 122V2 is set to have a quarter length (λ/4) of an electrical length of one wavelength λ in a communication frequency (resonant frequency) to serve as a monopole antenna. A point at which the loop part 114V2 is connected to the line between the grounded end 121V2 and the folded part 122V2 is an example of a second point.

Here, the loop part 114V2 serves as an inductor in coordination with the ground plane 50. Therefore, because of wavelength shortening effects, a length of the part of the feed element 110V2 from the feed point 111V2 to the open end 113V2 via the folded part 112V2 is shorter than a length of the part of the parasitic element 120V2 from the grounded end 121V2 to the open end 123V2 via the folded part 122V2.

Similar to the feed element 110 illustrated in FIG. 1, the feed element 110V2 serves as an inductor by the loop element 114V2, which serves as an inductor, being connected between the feed point 111V1 and the folded part 112V2.

Accordingly, by providing the metal sheet 130 so as to cover between the open end 113V2 of the feed element 110V2 and the open end 123V2 of the parasitic element 120V2, the impedance of the antenna apparatus 100V2 can be adjusted in accordance with the position of the metal sheet 130.

An antenna apparatus 100V3 illustrated in FIG. 14A includes the ground plane 50, a feed element 110V3, a parasitic element 120V3, and the metal sheet 130. In FIG. 14A, the corner part 51 of the ground plane 50 is an example of a first point, and the corner part 52 is an example of a second point.

The feed element 110V3 has a feed point 111V3, a folded part 112V3, an open end 113V3, and an inductor 114V3. The feed point 111V3 is located close to the corner part 51, and the feed element 110V3 extends from the feed point 111V3 to the open end 113V3 via the folded part 112V3. The open end 113V3 is an example of a first open end.

Further, the inductor 114V3 is connected between the feed point 111V3 and the edge 50A. When a microstripline or a core wire of a coaxial cable is connected to the feed point 111V3 to feed electric power to the feed point 111V3 and a ground potential wire included in the microstripline or a shielded wire of the coaxial cable is connected to the corner part 51, the inductor 114V3 is connected in parallel between the feed point 111V3 and (the ground potential point of) the corner part 51.

The parasitic element 120V3 has a grounded end 121V3, a folded part 122V3, and an open end 123V3. The grounded end 121V3 is connected to the corner part 52, and the parasitic element 120V3 extends from the grounded end 121V3 to the open end 123V3 via the folded part 122V3. The open end 123V3 is located a predetermined distance before the open end 113V3. Further, the open end 123V3 and the open end 113V3 are covered by the metal sheet 130. The grounded end 121V3 is an example of a first connection end, and the open end 123V3 is an example of a second connection end.

A length of a section from the open end 113V3 to the open end 123V3 via the folded part 112V3, the feed point 111V3, the corner part 51, the edge 50A, the corner part 52, the grounded end 121V3, and the folded part 122V3 is set to be a half length of an electrical length of one wavelength (λ) in a communication frequency (resonant frequency). That is, the length is set to be λ/2.

The inductor 114V3 is connected in parallel between the feed point 111V3 and the ground potential point. Thereby, the feed element 110V3 serves as an inductor similar to the feed element 110 illustrated in FIG. 1.

Accordingly, by providing the metal sheet 130 so as to cover between the open end 113V3 of the feed element 110V3 and the open end 123V3 of the parasitic element 120V3, the impedance of the antenna apparatus 100V3 can be adjusted in accordance with the position of the metal sheet 130.

An antenna apparatus 100V4 illustrated in FIG. 14B includes the ground plane 50, a feed element 110V4, a parasitic element 120V4, and the metal sheet 130. The antenna apparatus 100V4 has a configuration where the feed element 110V3 and the parasitic element 120V3 of the antenna apparatus 100V3 illustrated in FIG. 14A stand in a three-dimensional loop shape. The feed element 110V4 and the parasitic element 120V4 are obtained by standing the feed element 110V3 and the parasitic element 120V3 orthogonal to the ground plane 50 illustrated in FIG. 14A.

Even in such an antenna apparatus 100V4, by providing the metal sheet 130 so as to cover between the open end 113V4 of the feed element 110V4 and the open end 123V4 of the parasitic element 120V4, the impedance of the antenna apparatus 100V4 can be adjusted in accordance with the position of the metal sheet 130.

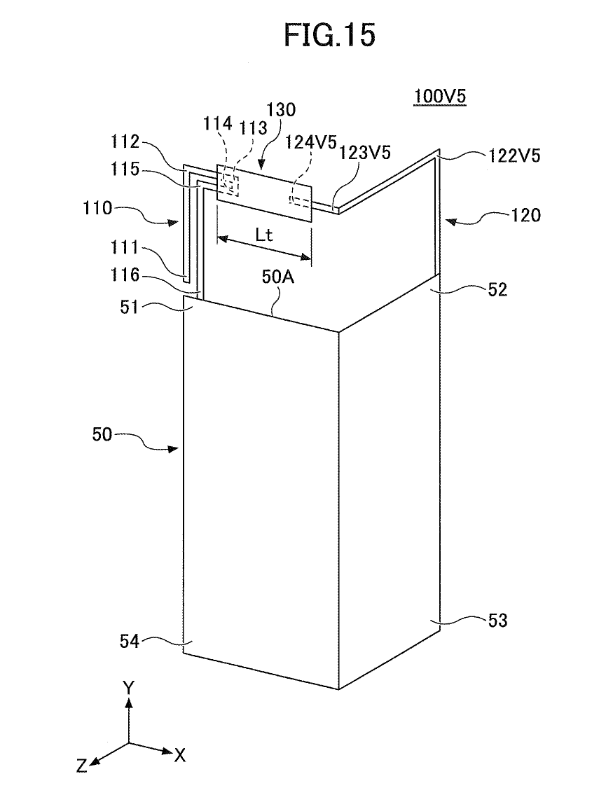

FIG. 15 is a diagram illustrating a variation example of the embodiment. The antenna apparatus 100V5 illustrated in FIG. 15 has a configuration in which the antenna apparatus 100 illustrated in FIG. 1 is folded along the Y axis. By forming the ground plane 50, the feed element 110, and the parasitic element 120 on a flexible substrate, the antenna apparatus 100V5 can be folded as illustrated in FIG. 15. As the flexible substrate, a film made of polyimide may be used other than a PET film.

Further, when the antenna apparatus 100V5 is folded as illustrated in FIG. 15, impedance of the feed element 110 and the parasitic element 120 may change. In such a case, the impedance of the antenna apparatus 100V5 may be adjusted with the metal sheet 130.

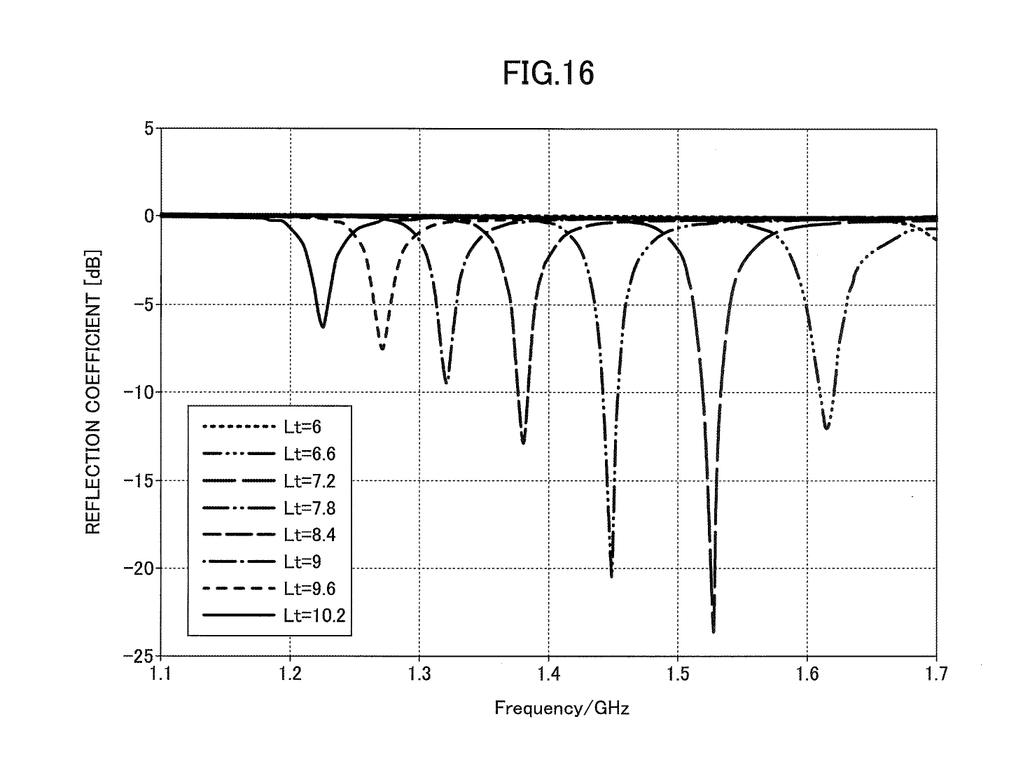

FIG. 16 is a graph illustrating a frequency property of reflection coefficients (S11-parameters) of the antenna apparatus 100V5. When the length Lt of the metal sheet 130 is changed, the frequency property of the reflection coefficients (S11-parameters) illustrated in FIG. 16 is obtained.

When the length Lt is changed from 6.0 mm to 10.2 mm, the reflection coefficient changes as illustrated in FIG. 16. As the length Lt increases, the frequency at which the local minimum value of the reflection coefficient is obtained decreases.

From such a result, it can be confirmed that by changing the length Lt of the metal sheet 130 to change the electrostatic capacity (capacitance) between the metal sheet 130, the feed element 110, and the parasitic element 120, the impedance of the antenna apparatus 100V5 can be adjusted and the communication frequency (resonant frequency) of the antenna apparatus 100V5 can be adjusted.

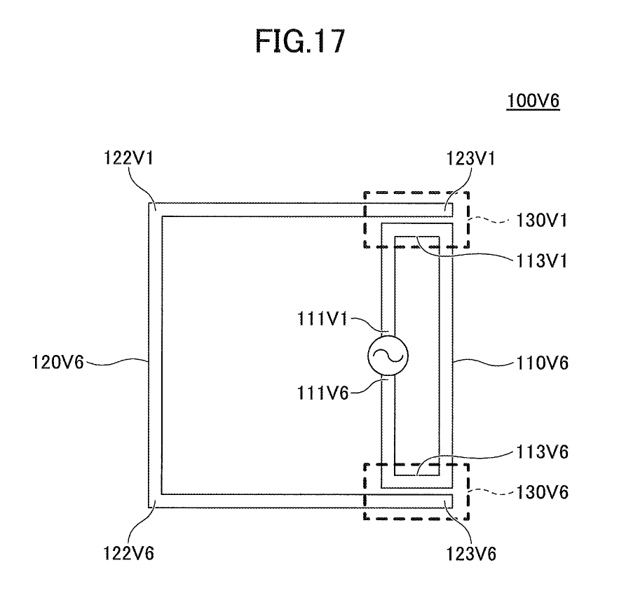

FIG. 17 is a diagram illustrating an antenna apparatus 100V6.

The antenna apparatus 100V6 illustrated in FIG. 17 includes a feed element 110V6, a parasitic element 120V6, and metal sheets 130V1 and 130V6. The antenna apparatus 100V6 has a configuration obtained by removing the ground plane 50 from the antenna apparatus 100S illustrated in FIG. 4 and replacing the mirror image part with an actual element.

The feed element 110V6 has a loop-shaped structure obtained by combining the feed elements 110S1 and 110S2 illustrated in FIG. 4. The feed element 110V6 has a feed point 111V1, a folded part 113V1, and a ground potential point 111V6, and a folded part 113V6. The folded part 113V1 is an example of a first point, and the folded part 113V6 is an example of a second point. Note that FIG. 17 illustrates a symbol for alternating current between the feed points 111V1 and the ground potential point 111V6.

The loop length of the feed element 110V6 is less than half of an electrical length of one wavelength in a communication frequency (the loop length is less than λ/2). Therefore, the feed element 110V6 serves as an inductor.

The parasitic element 120V6 has a folded part 122V1, a leading end part 123V1, a folded part 122V6, and a leading end part 123V6. The leading end part 123V1 is located close to the folded part 113V1. The leading end part 123V1 and the folded part 113V1 are covered by the metal sheet 130V1. The leading end part 123V6 is located close to the folded part 113V6. The leading end part 123V6 and the folded part 113V6 are covered by the metal sheet 130V6.

The leading end part 123V1 is an example of a first open end, and the leading end part 123V6 is an example of a second open end. It should be noted that the length between the leading end part 123V1 and the leading end part 123V6 may be λ/2.

According to such an antenna apparatus 100V6, the feed element 110V6 serves as a matching circuit, electric power is fed from the feed element 110V6 to the leading end parts 123V1 and 123V6 located close to the folded parts 113V1 and 113V6 of the feed element 110V6, and the parasitic element 120V6 serves as a dipole antenna. In this way, the antenna apparatus 100V6 becomes able to communicate.

As described above, even in the antenna apparatus 100V6 that does not include a ground plane, the impedance of the antenna apparatus 100V6 can be easily adjusted by adjusting the positions of the metal sheets 130V1 and 130V6.

Note that although the two metal sheets 130V1 and 130V6 are used in the embodiment described here, the antenna apparatus 100V6 may include at least one of the metal sheets 130V1 and 130V6.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the spirit and scope of the invention.

What is claimed is:

1. An antenna apparatus comprising:
a ground plane having an edge;
a feed element having a feed point located close to the edge of the ground plane and having a first open end, the feed element extending from the feed point to the first open end and serving as an inductor;
a parasitic element having a second open end that is disposed a predetermined distance away from the first open end of the feed element and having a connection end that is connected to the edge of the ground plane, the parasitic element extending from the connection end to the second open end, a length of the parasitic element from the connection end to the second open end being set to be a quarter wavelength of an electrical length of a wavelength in a communication frequency; and
a metal member disposed between the first open end and the second open end via a predetermined interval to cover the first open end and the second open end and configured to constitute a predetermined capacity between the first open end and the second open end.

2. The antenna apparatus according to claim 1, wherein the feed element is a loop-shaped element that has a grounded end connected, close to the feed point, to the ground plane, the loop-shaped element extending from the feed point to the first open end and being folded at the first open end to extend to the grounded end of the loop-shaped element.

3. The antenna apparatus according to claim 1, wherein the parasitic element is a loop-shaped element that has a second connection end that is connected, close to the connection end, to the ground plane, the loop-shaped element extending from the connection end to the second open end and being folded at the second open end to extend to the second connection end.

4. The antenna apparatus according to claim 1, further comprising:
a connection element that connects a first point, between the feed point and the first open end of the feed element, and a second point, between the connection end and the second open end of the parasitic element, and constitutes a loop that connects the first point, the feed point, an edge, the connection end, and the second point.

5. An antenna apparatus comprising:
a ground plane;
a feed element having a feed point located close to a first point of the ground plane and having a first open end, the feed element extending from the feed point to the first open end;
an inductive element inserted in parallel between the first point and the feed point;
a parasitic element having a connection end that is connected to a second point of the ground plane and having a second open end that is disposed a predetermined distance away from the first open end, the parasitic element extending from the connection end to the second open end; and
a metal member disposed between the first open end and the second open end via a predetermined interval to cover the first open end and the second open end and configured to constitute a predetermined capacity between the first open end and the second open end,
wherein a total length of a length from the first open end to the feed point, a length from the first point to the second point, and a length from the connection end to the second open end is set to be a half wavelength of an electrical length in a communication frequency.

6. An antenna apparatus comprising:
a feed element having a feed point and a ground potential point located close to the feed point and extending from the feed point to the ground potential point in a loop-shape, the feed element serving as an inductor;
a parasitic element having a first open end, disposed close to a first point between the feed point and the ground potential point of the feed element, and a second open end, disposed close to a second point between the first point and the ground potential point, the parasitic element extending from the first open end to the second open end, a length between the first open end and the second open end being set to be a half wavelength of an electrical length of a wavelength in a communication frequency; and
a metal member disposed between the first point and the first open end via a predetermined interval to cover the first point and the first open end and configured to constitute a predetermined capacity between the first point and the first open end.

7. The antenna apparatus according to claim 1, further comprising:
an insulation member, disposed between the first and second open ends and the metal member, and having a thickness corresponding to the predetermined interval.

8. The antenna apparatus according to claim 1, wherein a width of the metal member is wider than line widths of the feed element and the parasitic element.

9. The antenna apparatus according to claim 1, wherein the metal member is a metal sheet that is repeatedly attachable with respect to the first open end and the second open end.

10. The antenna apparatus according to claim 1, wherein the metal member has a plurality of metal sheets stacked with respect to the first open end and the second open end, lengths of the plurality of metal sheets being different from each other in a direction connecting the first open end and the second open end, the lengths of the plurality of metal sheets decreasing with decreasing distance to the first open end and the second open end in a direction of stacking the plurality of metal sheets with respect to the first open end and the second open end, the lengths of the plurality of metal sheets increasing with increasing distance from the first open end and the second open end in the direction of stacking the plurality of metal sheets with respect to the first open end and the second open end.

11. The antenna apparatus according to claim 1, wherein the metal member is rotatably supported by a rotation shaft and constitutes a variable capacity for which an area overlapping with the first open end and the second open end is changed by adjusting an angle of the metal member.
